(19) United States
(12) Patent Application Publication
(10) Pub. No.: US 2025/0104504 A1
(43) Pub. Date: Mar. 27, 2025

(54) Serviceable Surface Mount Button Assembly with Infrared Sensor Detection for Electronic Gaming Devices and Systems

(71) Applicant: Aristocrat Technologies, Inc. (ATI), Las Vegas, NV (US)

(72) Inventors: Lindsay McClintock, Las Vegas, NV (US); Xiaoqiang Gong, Henderson, NV (US); Donald Twyman, Las Vegas, NV (US); Stephen Shaffer, JR., Las Vegas, NV (US)

(21) Appl. No.: 18/787,566

(22) Filed: Jul. 29, 2024

Related U.S. Application Data
(60) Provisional application No. 63/540,904, filed on Sep. 27, 2023.

(51) Int. Cl. G07F 17/32

(52) U.S. Cl. CPC G07F 17/3209; G07F 17/3211

(57) ABSTRACT

A gaming system having a field serviceable input assembly on an aperture-less glass. The input assembly includes a rotational lock mounted on the aperture-less glass, a displacement detection that utilizes infrared time of flight (IR-TOF) sensors. The input assembly includes mechanical components that are mounted on top of the aperture-less glass, and electronic components that are protected beneath the aperture-less glass. The rotational lock secures the top assembly on the aperture-less glass with flanges and fasteners.

### RELATED APPLICATION

The present application claims priority to U.S. Provisional Patent Application No. 63/540,904, filed Sep. 27, 2023, and entitled “Serviceable Surface Mount Button Assembly with Infrared Sensor Detection for Electronic Gaming Devices and Systems” which is hereby incorporated by reference in its entirety.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

Input devices for game machines are a key to consistent and reliable game machine operation. Typical gaming machines have a variety of input devices, such as buttons to perform different functions for the gaming machines, e.g., activation by a player to select game preferences, activate a game sequence, or otherwise provide input to the EGM. For example, some input devices respond to player inputs for activating different games or actions. Other input devices may allow players to select some of the available paylines. Some input devices may also provide feedback to players to communicate game information or image.

Mechanical buttons are typically arranged in combination with a surface of the EGM cabinet. This button configuration is sometimes referred to as a “button deck.”

Sometimes these button decks may include a display that displays virtual buttons, called a virtual button deck (VBD) configuration. One or more mechanical buttons may be included in a VBD configuration. These mechanical buttons integrated in the button deck may include changing the graphics, colors, videos, or animations in a video display beneath the buttons to accommodate different wagering games or appearances. Mechanical buttons in these circumstances extend through the display of the virtual button deck such that an operative structure, e.g., plunger, passes through one or more apertures, cutouts, holes, or other infiltration points through the button deck surface to connect the switch and harness underneath the button deck surface. Some button decks also include traditional physical switches, beam breakers, and pressure breakers integrated in a printed circuit board (PCB) surface that allows wires and other components to pass through the surface.

However, because these existing button decks are implemented with one or more apertures cutouts, openings, channels, lumens, or holes in a glass or other substrate surface on the gaming machines, ingress risks are heightened. Those ingress risks are undesirable to the EGM. For example, undesirable ingress may be due to infiltration of food and/or drinks being consumed while operating EGMs or due to other debris. The cutouts, openings, channels, lumens, holes, or other infiltration points through the display of the virtual button deck allow food, liquid, or other debris to penetrate the VBD and access electronics of the EGM. This can result in interference with the operation of the EGM (e.g., shutdown, intermittent operation, and damage) which can be costly and inconvenient. Additionally, the cutouts, openings, channels, lumens, holes, or other infiltration points add structural stress and strain points in VBD substrates that can increase the failure rate of the button or button deck due to structural failures.

Additionally, the input devices must endure significant duty cycles from repeated use while in operation that can lead to damage and other unavoidable wear and tear. For example, the VBDs are often pounded on or otherwise abused by the player. When the input devices need replacement after such damage or wear and tear, the input device needs to be quickly and easily replaced to keep the gaming machine in operation. As such, longevity and reliability of these typical button decks may become an issue after multiple rounds, or long periods of plays.

Beyond facilitating user input from, and game feedback to, a player, typical button decks with holes are not effective at restricting ingress of liquid spills or substances that could impact operation of the game electrically or mechanically. Such impacts could also affect the feedback to the player before, during or after a game operation of the game machine. For example, the button could be stuck making it difficult to push or activate the input device, or activating any lighting or sound effect could be disabled.

Decreasing downtime from such servicing reduces the cost to the game machine owner. That is, when these typical input devices malfunction, the game machine becomes inoperable, or require services or replacements by field technicians, respective gaming devices become unavailable for game plays, which translates into loss of revenues.

Further limitations and disadvantages of conventional and traditional approaches will become apparent to one of skill in the art, through comparison of such systems and devices with some aspects of the present disclosure as set forth in the remainder of the present application with reference to the drawings.

### SUMMARY

In an implementation, a gaming system or gaming device comprises an input assembly on an aperture-less glass. The input assembly includes a unique rotational lock that is secured with a set screw, and is mounted on the aperture-less glass. The input assembly has a detection that utilizes infrared time of flight (IR TOF) sensors. Lighting in the input assembly may be configured to re-create typical lighting effects and to provide additional display options such as, multicolor, rainbow, and chase sequences. Mechanical components in the input assembly are fully serviceable, and electronic components of the input assembly are protected under the glass. The input assembly is generally spill-proof, retrofittable, and field serviceable.

In some examples, the instant disclosure provides a gaming system or gaming device that comprises an input assembly on an aperture-less glass. The input assembly comprises a base mount fixed on a top side of the aperture-less glass, the base mount having a plurality of flanges for receiving a top assembly. The top assembly includes a diffuser mount having a lip to secure the diffuser mount to the base mount. The lip defines one or more mount apertures operable to rotatably receive and secure the flanges. After the mount apertures have received the flanges, the top assembly may be rotated to secure the top assembly at the base mount. The top assembly also includes a sponge, a lens for projecting lights, information, videos, or images, and a gasket for sealing the lens and a frame.

In some aspects, the frame and the diffuser mount securely sandwich the sponge, the gasket, and the lens for the button top assembly.

In some aspects, the diffuser mount includes one or more threaded apertures for receiving one or more fasteners to secure the diffuser mount to the base mount.

In some aspects, the input assembly also includes a plurality of compression springs for returning the lens from a depressed position to a home position.

In some aspects, the input assembly also includes a bottom assembly attached to a bottom side of the aperture-less glass.

In some aspects, the bottom assembly includes electronic components such as a printed circuit board assembly (“PCBA”) holder operable to house a PCBA that further includes sensors operable to detect movements proximate to the gaming device, acceleration, and velocity of the movements of the lens, amounts of displacement of the lens.

In some aspects, the sensors include infrared time of flight (IR-TOF) sensors.

In some aspects, the PCBA further includes LED's operable to emit lights of different colors, and optionally at different angles.

In some aspects, the PCBA further includes a projector or a display device operable to animate at least one of an image, a text message, and a video sequence towards the lens.

In some aspects, the PCBA is coupled to a projector or a display device operable to display at least one of an image, a text message, and a video sequence towards the lens.

In some aspects, at least a portion of the bottom side of the aperture-less glass is painted black.

In some aspects, at least a portion of the aperture-less glass is a ceramic glass.

In some aspects, at least a portion of the aperture-less glass includes a touch screen.

In some examples, the instant disclosure provides an input assembly on an aperture-less glass. The input assembly comprises a base mount fixed on a top side of the aperture-less glass, the base mount having a plurality of flanges for receiving a top assembly. The top assembly includes a diffuser mount having a lip to secure the diffuser mount to the base mount. The lip defines one or more mount apertures operable to rotatably receive and secure the flanges. After the mount apertures have received the flanges, the top assembly is rotated to secure the top assembly at the base mount. The top assembly also includes a sponge, a lens for projecting lights, information, videos, or images, and a gasket for sealing the lens and a frame.

In some examples, the instant disclosure provides a rotational lock fixed on an aperture-less glass. The rotation lock has a plurality of flanges for receiving a button assembly that includes a mount positioned in a button frame on a side of the aperture-less glass, and an electronic board having sensors on an opposite side of the aperture-less glass. The button frame may be rotatably secured to the mount at the rotational lock. The button frame may be configured to displace from a home position to a pushed position, and to return from the pushed position to the home position via one or more compression springs. Amounts of displacement may be detected by the sensors mounted on the opposite side through the aperture-less glass.

In some examples, the instant disclosure provides a method of installing a serviceable assembly for use with a gaming device. The gaming device comprises an aperture-less glass, the method comprising forming a top assembly from a diffuser having a receiving hole and a first channel, a gasket having a second channel, a lens, and a frame having a third channel, including aligning the first channel, the second channel, and the third channel to form a fourth channel for receiving a fastener. The method also includes bonding a rotational lock having a flange to the aperture-less glass, inserting the top assembly to the rotational lock to align the flange with the receiving hole, rotating the top assembly with respect to the rotational lock, and threading the fastener into the fourth channel to lock the top assembly to the rotational lock.

In some examples, the instant disclosure provides a gaming system that comprises a substrate having a first side and a second side opposite the first side, a base mount being fixed on an aperture-less portion of the substrate on the first side, and a first assembly having a button and a diffuser. The first assembly is removably secured on the base mount, and the button is returnably moveable between a first position and a second position different from the first position when the button is actuated resulting in a displacement. The diffuser separates the button from the base mount. The gaming system also includes a second assembly fixed to the second side of the substrate and having a plurality of sensors operable to transmit lights through the aperture-less portion of the substrate onto the button, and to generate data indicative of the displacement of the button based on the lights transmitted when the button is actuated, and wherein the diffuser is operable to diffuse at least a portion of the lights transmitted into a lit ring above the top side around the first assembly.

In some aspects, the base mount includes a plurality of flanges operable to receive the first assembly, and wherein at least one of the flanges defines a through hole to receive one or more fasteners to secure the first assembly to the base mount.

In some aspects, the diffuser is further operable to absorb another portion of the lights transmitted to prevent unintended lights from escaping into the button.

In some aspects, the first assembly further comprises a frame sandwiching the button and the base mount.

In some aspects, the button comprises a lens operable to display at least one of an image and a video.

In some aspects, the first assembly further comprises a plurality of compression springs operable to return the button from the second position to the first position.

In some aspects, the plurality of sensors include infrared time of flight sensors.

In some examples, the instant disclosure provides a gaming input assembly that includes an aperture-less substrate having a first side and a second side opposite the first side, a rotational lock being fixed on the aperture-less substrate on the first side, and a diffuser lockable to the rotational lock. The gaming input assembly also includes a button having a tab, and being returnably moveable between a first position and a second position relative to the first side when the button is actuated resulting in a displacement, and wherein the diffuser separating the button from the rotational lock. The gaming input assembly also includes a frame sandwiching the button at the tab and the diffuser on the first side, the frame being rotatably secured to the rotational lock, and a holder housing a plurality of sensors, and being mounted on the second side, the plurality of sensors being operable to transmit lights through the aperture-less substrate onto the tab, and to generate data indicative of the displacement of the tab based on the lights transmitted when the button is actuated, and wherein the diffuser is operable to diffuse at least a portion of the lights transmitted into a lit ring above the first side around the frame.

In some aspects, the rotational lock comprises a plurality of flanges operable to receive the diffuser, and wherein at least one of the flanges defines a through hole to receive one or more fasteners to secure the diffuser to the flanges.

In some aspects, the diffuser is operable to diffuse at least a portion of the lights emitted such that the portion of the lights emitted is observable around the button.

In some aspects, the button comprises a lens operable to display at least one of an image and a video.

In some aspects, the gaming input assembly further comprises a plurality of compression springs operable to return the button from the second position to the first position.

In some aspects, the plurality of sensors include infrared time of flight (IR-TOF) sensors.

In some examples, the instant disclosure provides a method of implementing a serviceable assembly for use with a gaming device, the gaming device comprises an aperture-less substrate having a top side and a bottom side opposite the top side, a lens, a diffuser having a first channel, a gasket having a second channel, a rotational lock having a flange, a frame having a third channel, and a holder having a plurality of sensors. The method includes bonding the rotational lock to the aperture-less substrate on the top side, forming the serviceable assembly including aligning the first channel, the second channel, and the third channel to form a fourth channel, and rotatingly locking the serviceable assembly to the rotational lock, and securing the frame to the rotational lock with a fastener through the fourth channel. The method also includes bonding the holder on the bottom side of the aperture-less substrate, transmitting a plurality of lights through the aperture-less substrate onto the lens and the diffuser, diffusing at least a portion of the lights transmitted into a lit ring above the top side around the serviceable assembly, and generating data indicative of a displacement of the lens when the lens is actuated based on the lights transmitted when the lens is actuated.

In some aspects, the aperture-less substrate is ceramic glass, or a clear acrylic base.

In some aspects, the method includes controlling the diffuser to absorb another portion of the lights transmitted to prevent unintended lights from escaping into the lens.

In some aspects, the method includes sandwiching the lens and the rotational lock with the diffuser.

In some aspects, the method includes displaying through the lens at least one of an image and a video.

In some aspects, the method includes positioning a plurality of compression springs on the diffuser, and biasing the lens to return from a displaced position to a home position with the compression springs.

In some aspects, the plurality of sensors include infrared time of flight sensors.

### BRIEF DESCRIPTION OF THE DRAWINGS

FIG. 1 is an exemplary diagram showing several EGMs networked with various gaming-related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 illustrates a perspective view of an input assembly.

FIG. 5A, FIG. 5B and FIG. 5C illustrate a front view, a perspective view, and an exploded view of an input assembly, respectively.

FIG. 6 illustrates a frame for use with an input assembly.

FIG. 7 illustrates a lens for use with an input assembly.

FIG. 8 illustrates a gasket for use with an input assembly.

FIG. 9 illustrates a diffuser for use with an input assembly.

FIG. 10 illustrates a base for use with an input assembly.

FIG. 11 illustrates a PCBA board for use with an input assembly.

FIG. 12 illustrates a PCBA board holder for use with an input assembly.

FIG. 13A and FIG. 13B illustrate different cross-sectional views of an input assembly.

FIG. 14 illustrates an installation process of a serviceable assembly.

### DETAILED DESCRIPTION

Implementations of the present disclosure represent a technical improvement in the art of gaming technology. Specifically, the implementations illustrated address the technical problem of ingress risk, as experienced by typical input devices.

Implementations of the present disclosure employ a button assembly having a bash button and utilizes button-on-glass (BOG) concepts having an aperture-less glass. Displacements or movements of the bash button assembly may be detected with infrared time of flight (IR TOF) sensors. Lighting in the button assembly may re-create current lighting effects and provide additional options such as rainbow and chase sequences. The button assembly is mounted to the aperture-less glass through a rotational lock that is secured with a set screw. The button assembly includes mechanical components that are fully serviceable, whereas electronic components are protected under the aperture-less glass.

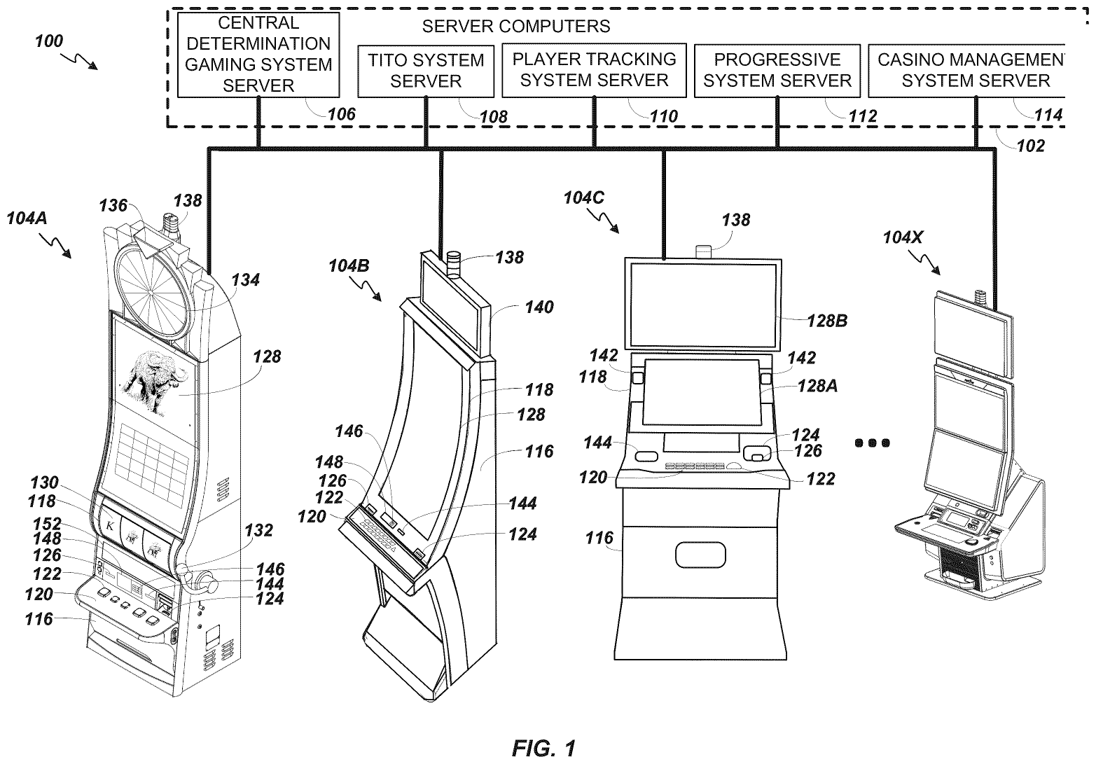

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementations, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In some examples, the buttons 122 in the button deck 120 can be physical buttons, or other player-actuatable selection elements, such as switches, dials, knobs, and the like. In further examples, the button deck 120 can be a virtual button deck and can be, or include, a display, such as a capacitive touchscreen. The buttons 122 can be virtual buttons, or other selection elements, which can be actuated through suitable player interaction (e.g., by performing pressing, swiping, dragging, or similar actions on the display of the virtual button deck 120). The virtual button deck can include a combination of pushbuttons and virtual buttons. Suitable virtual button decks 120 include the virtual button deck included in the Helix XT™ model gaming device manufactured by Aristocrat® Technologies, Inc. Although described with respect to the gaming device 104A, the button decks 120 of one or both of gaming devices 104B or 104C can be virtual button decks having virtual buttons 122 and/or pushbuttons 122.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), win paths (e.g., pay lines), pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

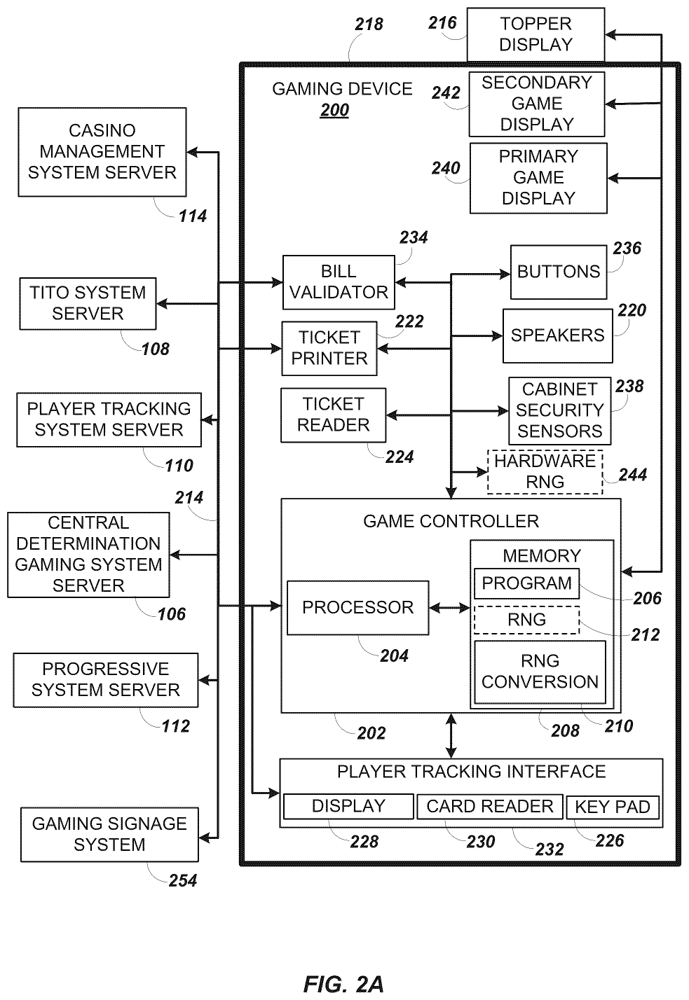

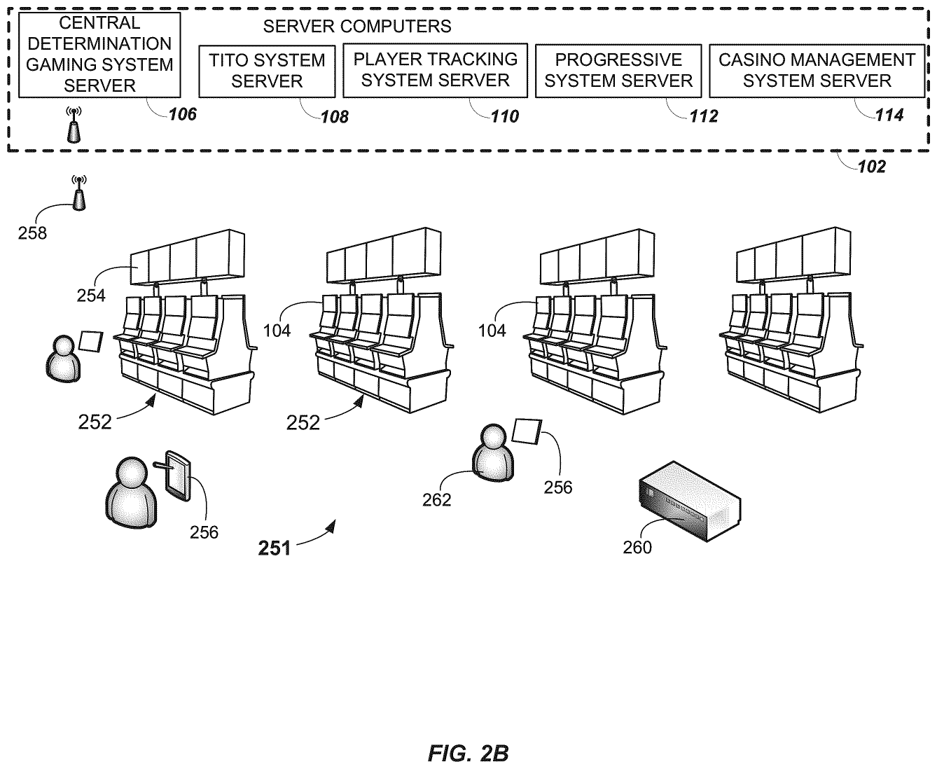

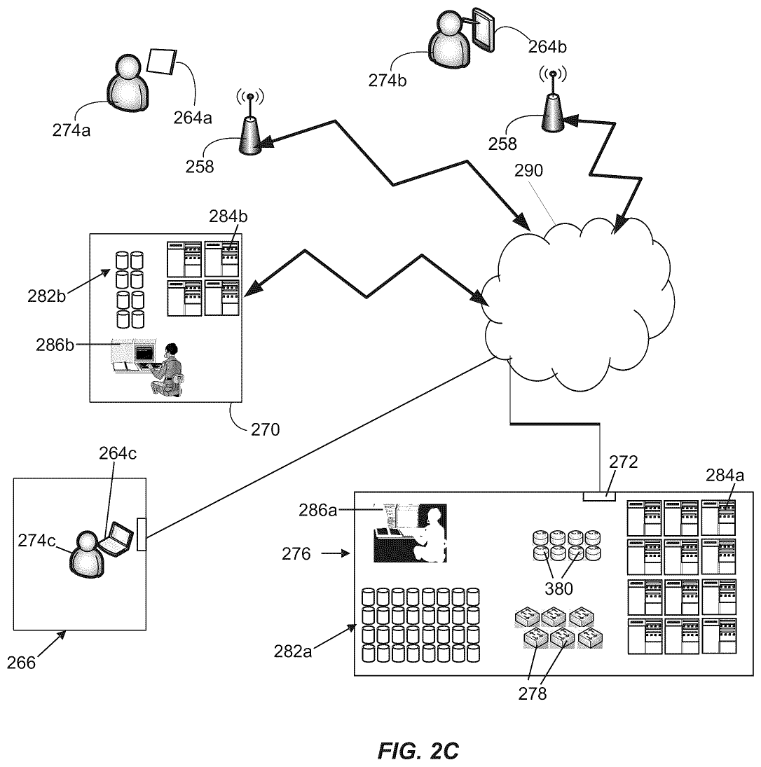

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify, and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, the main display 128A is a flat panel display. Main display 128A is typically used for primary game play while secondary display 128B is typically used for bonus game play, to show game features or attraction activities while the game is not in play, or any other information or media desired by the game designer or operator. In some implementations, exemplary gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for playing on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that does not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically crasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility. A weighted table is one type of lookup table, and the two terms can be used interchangeably throughout the present disclosure.

The lookup tables, in the form of weighted tables, can have one of many possible configurations. In general, a weighted table can be implemented as any data structure that assigns probabilities to different options, in order for one of the different options to be selected using a random number. Different options are represented in different entries of a weighted table. For example, there may be multiple possible values within each tier of the weighted table, and the multiple possible values may be unequally weighted. The probabilities for different options can be reflected in threshold values (e.g., for a random number RND, generated by an RNG, in the range of 1<RND<=40 for option 1, 40<RND<=70 for option 2, 70<RND<=90 for option 3, and 90<RND<=100 for option 4, given four options and a random number RND where 0<RND<=100). The threshold values can represent percentages or, more generally, sub-ranges within the range for a random number. In some example implementations, the threshold values for a weighted table are represented as count values for the respective entries of the weighted table. For example, the following table shows count values for the four options described above:

Example Weighted Table

| Count Value | Entry |
|---|---|
| 40 | <value a1, value a2, . . . > |
| 30 | <value b1, value b2, . . . > |
| 20 | <value c1, value c2, . . . > |
| 10 | <value d1, value d2, . . . > |

The sum total of the count values indicates the range of the options. Control logic can use a random number, generated between 1 and the sum total of the count values, to select one of the entries in the weighted table by comparing the random number to successive running totals. In the example shown in Table 1, if the random number is 40 or less, the first entry is selected. Otherwise, if the random number is between 41 and 70, the second entry is selected. Otherwise, if the random number is between 71 and 90, the third entry is selected. Otherwise, the last entry is selected.

The threshold values for a weighted table can be fixed and predetermined. Or the threshold values for a weighted table can vary dynamically (e.g., depending on bet level). Or a weighted table can be dynamically selected (e.g., depending on bet level) from among multiple available weighted tables. Different parameters or choices during game play can use different weighted tables. Or different combinations of parameters or choices can be combined in entries of a given weighted table.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment, and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect the play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate case of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones, and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface on a virtual button deck), or a dynamic pushbutton in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types, and arrangements of gaming devices shown in FIG. 2C are merely shown by way of example. In this example, various gaming devices, including but not limited to end user devices (EUDs) 264a, 264b and 264c are capable of communication via one or more networks 290. The networks 290 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 290. The gaming data center 276 is capable of communication with the networks 290 via the gateway 272. In this example, switches 278 and routers 280 are configured to provide network connectivity for devices of the gaming data center 276, including storage devices 282a, servers 284a and one or more workstations 570a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 290. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 290. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

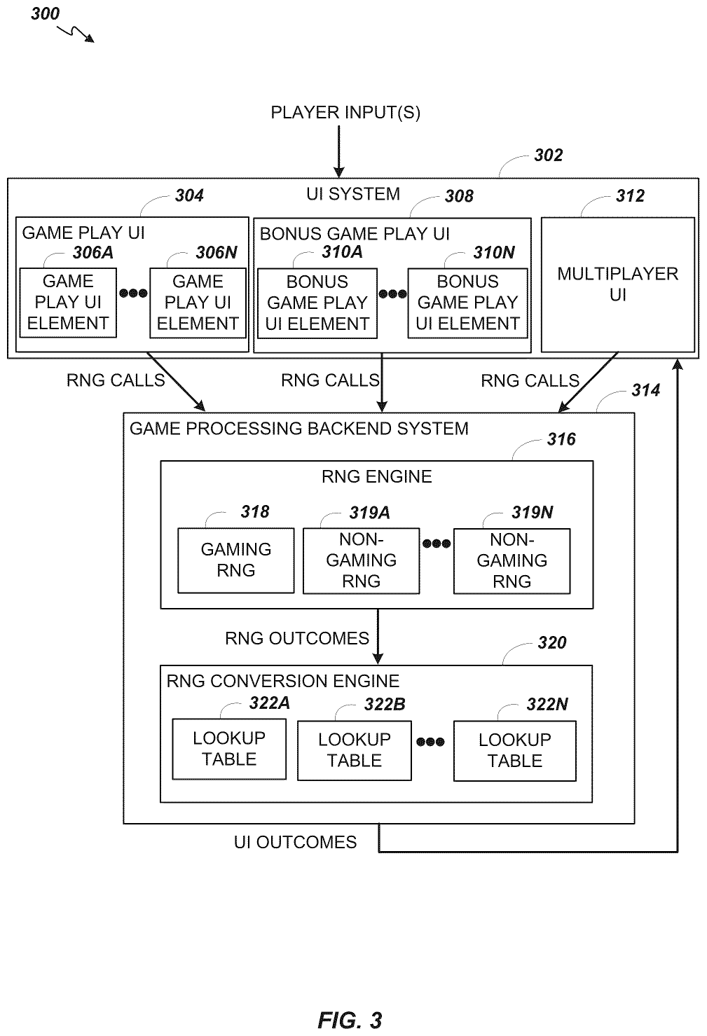

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could correspond to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

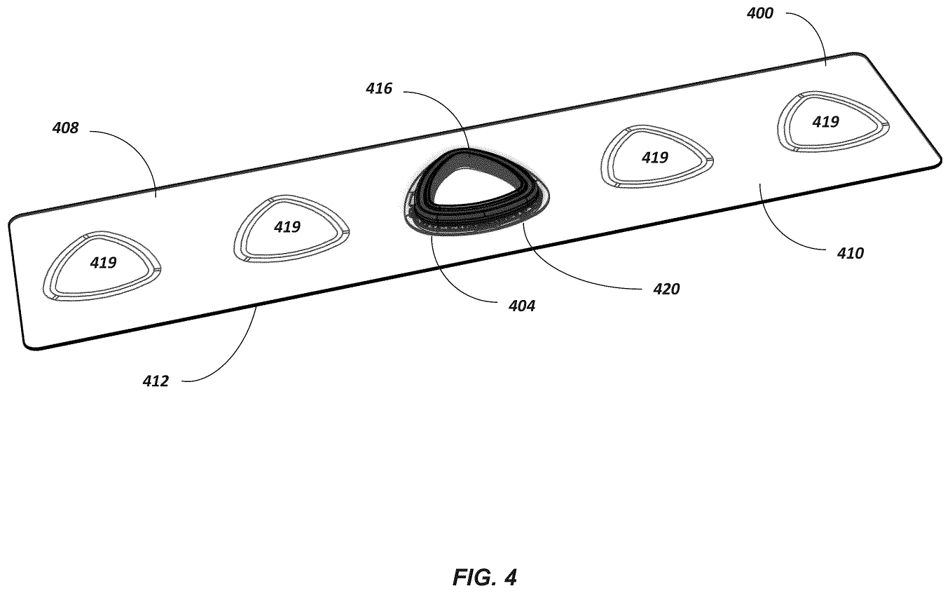

FIG. 4 illustrates a perspective view of a button deck 400 (similar to the button deck 120 of FIG. 1) having a button-on-glass or input assembly 404 (similar to the button 122 of FIG. 1). In the example shown, the substrate 410 may also include two opposing surfaces (e.g., upper and lower surface) and a plurality of receiving pads 419 on a first surface (e.g., the upper surface). As shown, each receiving pad 419 may have a Rouleaux triangular or a triangular shape having an interior portion with dual ridges at its perimeter for receiving the input assembly 404. For example, a portion of the input assembly 404 is mounted on an upper surface or top side 408 of an aperture-less substrate 410 at receiving pad 419; and a separate portion of the input assembly 404 is mounted on a lower surface or bottom side 412 of the aperture-less glass 410. The portion of the input assembly 404 mounted on the top side 408 is a top assembly 416 and generally includes mechanical components detailed hereinafter. The portion of the input assembly 404 mounted on the bottom side 412 is a bottom assembly 420 beneath an innermost ridge of the dual ridges, and generally includes electronic components detailed hereinafter. By way of further example, the substrate 410 may also be oriented on the side of the EGM or at an angle in relation to the EGM.

In some examples, at least a portion of the aperture-less substrate 410 is made with a ceramic glass. In other examples, at least the portion of aperture-less substrate 410 is made with a clear acrylic base to yield a transparent button deck or the acrylic base can be further modified with a coating to yield an opaque deck or any desired appearance. The aperture-less substrate 410 may also comprise a housing, a sheet of glass, a sheet of plastic, a screen, a display, and a combination thereof.

In some examples, at least a portion of the bottom side 412 of the aperture-less glass 410 is coated or tinted black. In some examples, at least a portion of the aperture-less glass 410 includes a touch screen. In some examples, the input assembly 404 may communicate with a projector or a display device (not shown) coupled to the bottom assembly 420. In some examples, the display device may be configured to animate at least one of an image, a text message, and a video sequence from beneath the bottom side 412 upward towards the top side 408. In some examples, at least a portion of the image, the text message, or the video sequence projected or displayed may be viewed through the top assembly 416 or button deck 400.

In the example of FIG. 4, the input assembly 404 is in the shape of a Rouleaux triangle with three lobes or corners. In other examples, the input assembly 404 may be any of a variety of shapes, including but not limited to, a circle, a triangle, a square, a pentagon, a hexagon, an oval, an alphanumeric character, a symbol, another shape, or the like.

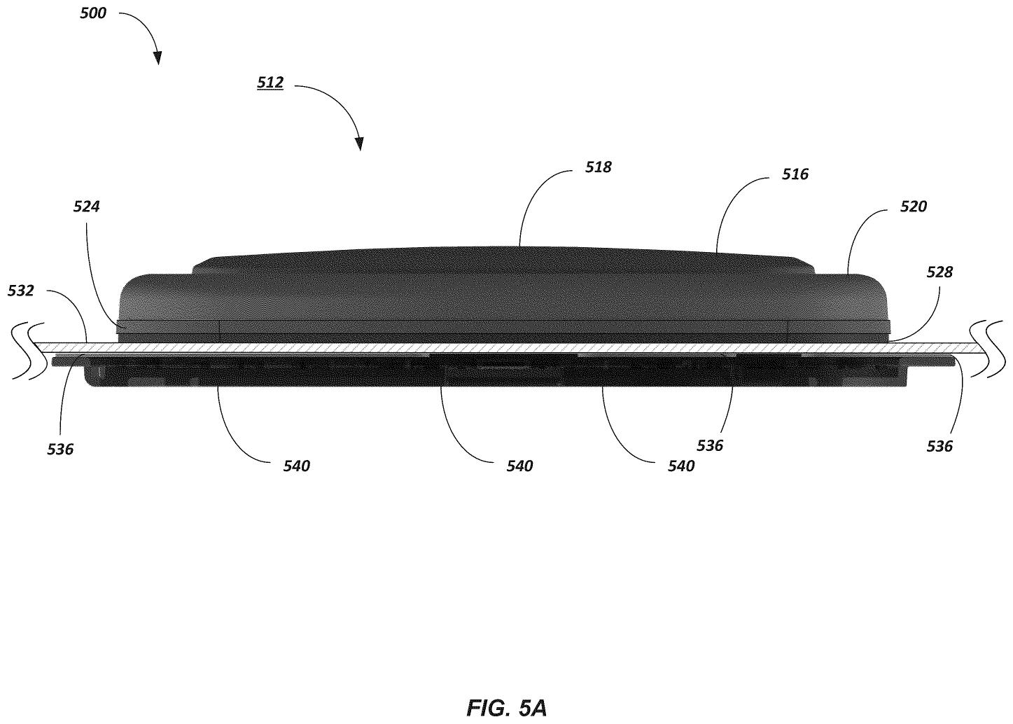

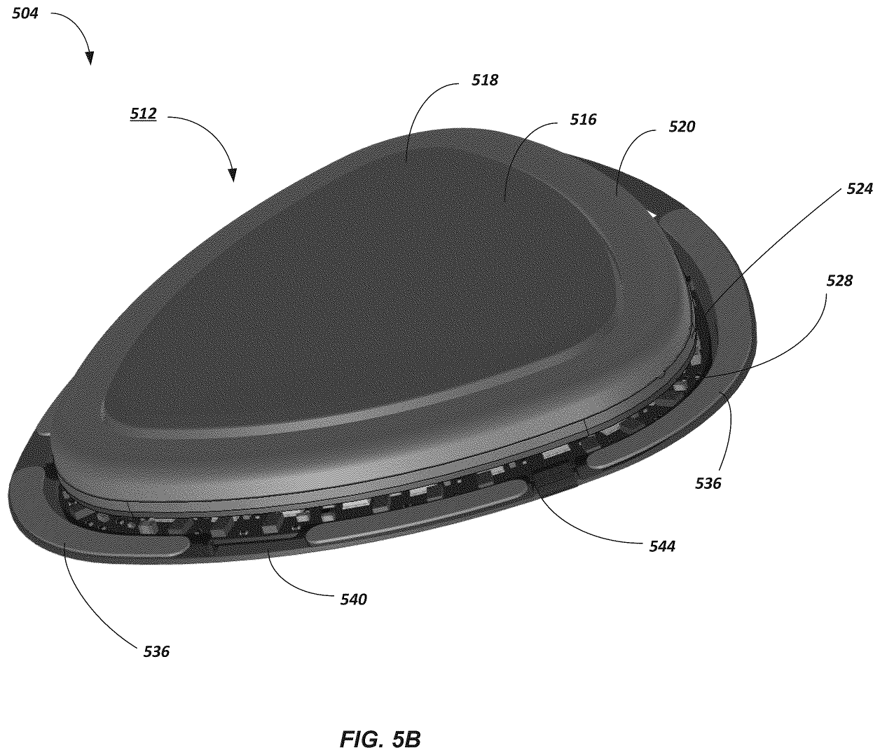

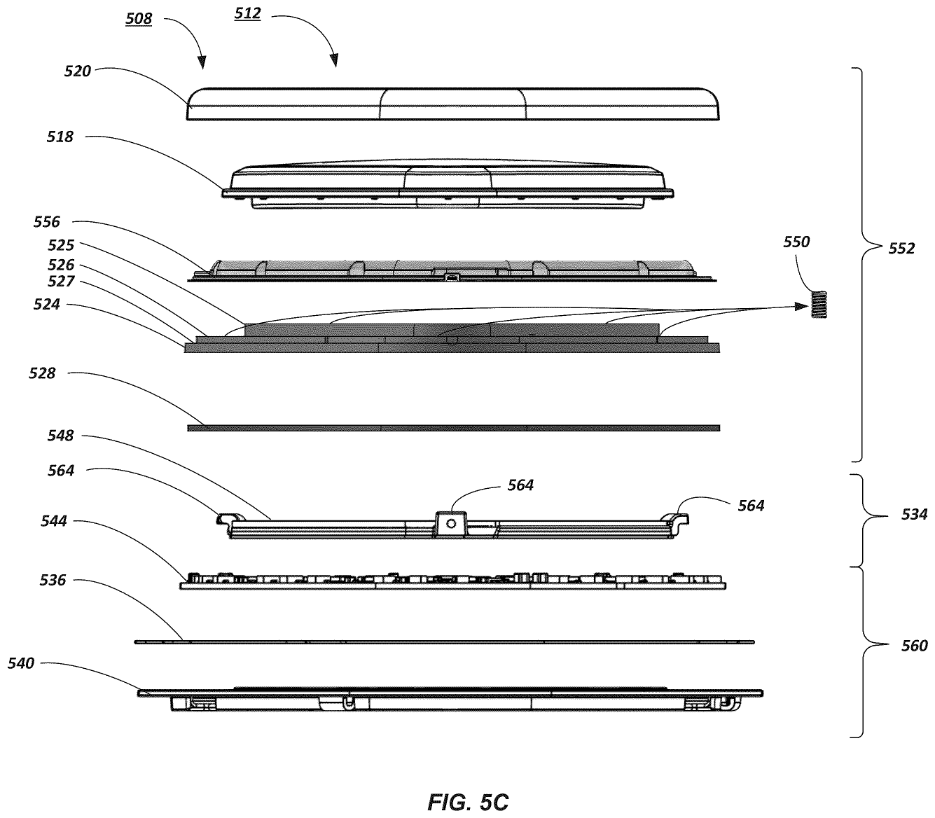

FIG. 5A, FIG. 5B and FIG. 5C illustrate a front view 500, a perspective view 504, and an exploded view 508 of an input assembly 512, respectively, wherein like numerals refer to like parts, and wherein some parts are removed for clarity purposes. As shown, the input assembly 512 includes a contact surface 516. In some examples, the contact surface 516 may include a lens 518. In the example shown, the contact surface 516 or the lens 518 is displaced downwards from a home position when a player presses the contact surface 516 or the lens 518, and is returned, bounces back, or moving upward towards the home position when the player releases the contact surface 516 or the lens 518.

In some examples, the lens 518 may be transparent for animating at least one of an image, a text message, and a video sequence from beneath the bottom side 412. In some examples, the lens 518 may also be configured to reflect lights emitted from beneath the aperture-less substrate 410 of FIG. 4. In still other examples, the contact surface 516 may include a display therein for animating at least one of lights, an image, a text message, and a video sequence. In other examples, the contact surface 516 may be opaque. In still other examples, the contact surface 516 may be colored.

Referring back to FIG. 5A, FIG. 5B and FIG. 5C, the input assembly 512 includes a frame 520 to secure the contact surface 516 or the lens 518, as detailed hereinafter. The input assembly 512 also includes a diffuser 524 for diffusing a portion of lights emitted such that the portion of lights may be observed around the diffuser 524. The input assembly 512 may also include a fluid seal 528, e.g., a sponge, configured to provide a fluid seal effect to prevent, reduce, or minimize fluid or other debris from entering or seeping into the input assembly 512. The lens 518, the frame 520, the diffuser 524, and the fluid seal 528 are locked onto a base mount or a rotational lock 548 (FIG. 5C) that is fixed to, or surface mounted onto, a portion of an aperture-less glass 532 (similar to the aperture-less glass 410 in FIG. 4.) In the example shown in FIG. 5C, the diffuser 524 is a three-step diffuser having a top step 525, a middle step 526, and a bottom step 527. The top step 525 is generally the narrowest step among the three steps, while the bottom step 527 is generally the widest step among the three steps. In the example shown, compression springs 550 may reside on, for example, the middle step 526 of the diffuser 524 between the top step 525 and the bottom step 527 in the diffuser 524. In other examples, the diffuser 524 may have more or less steps, and the compression springs 550 may reside on any of the steps. In still other examples, the diffuser 524 may have a generally concave surface (not shown), and the compression springs 550 may reside in indentations (not shown) on the concave surface.

Further, while the illustrated example includes a button frame 520 in the same general shape as the contact surface 516 or the lens 518, in other examples, the frame 520 and the contact surface 516 or the lens 518 may comprise different shapes so long as the input assembly 404 can function as described with regard to, while also fitting into a receiving pad of the plurality of receiving pads 419, one or more examples. Additionally, while frame 520, contact surface 516 or the lens 518 includes three lobes or corners, other examples may include more or less lobes or corners.

A printed circuit board assembly (PCBA) housing, or a PCBA holder 540 is positioned on a bottom side of the aperture-less glass 532. FIG. 5B shows that the PCBA holder 540 houses a PCBA 544 that includes sensors and LEDS, detailed hereinafter. The PCBA holder 540 is attached to the bottom side of the aperture-less glass 532 with a very high bond (VHB) adhesive layer 536. More particularly, adhesive layer 536 can be placed on elevated sections of the PCBA holder 540. Although not shown, an interior portion of the aperture-less glass 532 corresponding to the rotational lock 548 may be a clear glass, and is surrounded by a dark colored rim for positioning the input assembly 512 during installation, and for preventing unintended lights from escaping into the lens 518 (e.g., the dark colored rim may absorb lights of particular wavelengths). As such, when the diffuser 524 receives lights from the PCBA 544, the diffuser 524 as viewed by a player presents a “halo” effect that looks like a lighted ring around the input assembly 512.

In some examples, the rotational lock 548 may be fixed to the aperture-less glass 532 with adhesives including, but not limited to, cyanoacrylate-based adhesives, very-high-bond (VHB) adhesives, and epoxies. For example, the cyanoacrylate-based adhesives, the VHB adhesives, or the epoxies may be applied to both a bottom side of the rotational lock 548 and a corresponding portion of the top side 408 of the aperture-less glass 532 in FIG. 4. The rotational lock 548, which includes flanges 564, can impart a sufficiently stabilizing effect to glass assembly 534, wherein the sufficiency stabilizing effect ensures the glass assembly 534 remains securely fastened with, i.e., operatively connected to, the bottom assembly 560. Other adhesives may also be used to fix the rotational lock 548 to the aperture-less glass 532, including, not limited to, pressure sensitive adhesives (PSA), assembly-resistant adhesives, anisotropic adhesives, and the like.

In some examples, the lens 518, the frame 520, the diffuser 524, and the fluid seal 528 form the top assembly 416 as discussed above in FIG. 4. The top assembly 416 may be locked onto the rotational lock 548 to form a portion of the input assembly 512 on top of the aperture-less glass 532. In such cases, the top assembly 416 may be individually serviceable.

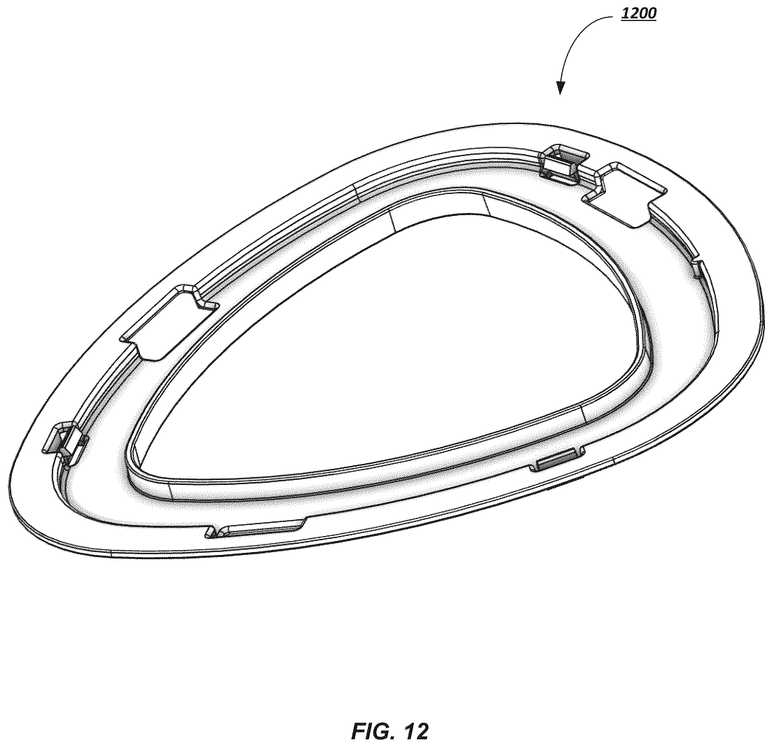

Although not shown in FIG. 5C, glass assembly 534 includes the rotational lock 548 adhered to the aperture-less glass 532 of FIG. 5A. Further, in the example as shown in FIG. 5C, top assembly or serviceable assembly 552 may be formed from the lens 518, the frame 520, the diffuser 524, and the fluid seal 528; and a bottom assembly 560 may be formed from the PCBA holder 540 and the PCBA 544, and attached to the aperture-less glass 532 with the VHB layer 536. Serviceable assembly 552 is similarly locked onto the rotational lock 548, detailed hereinafter. In some examples, the serviceable assembly 552 may employ a plurality of compression springs 550 contacting and biasing against the lens 518 or the contact surface 516 to provide a feel of the contact surface 516 when locked onto the rotational lock 548 and when the lens 518 or the contact surface 516 is pressed. One or more compression springs 550 is generally configured to bias the contact surface 516 toward the home position. For example, after the contact surface 516 is displaced from the home position in response to the contact surface 516 having been pressed downward thus compressing the compression spring 550, the contact surface 516 may be released thus decompressing the compression spring 550 to return the contact surface 516 back towards the home position. The rotational lock 548 may be permanently bonded, adhered, mounted, or attached to the aperture-less glass 532, and includes a plurality of locking mechanisms 554. In some examples, the locking mechanisms 554 are in the form of a plurality of flanges that are received at corresponding apertures defined by the diffuser 524, detailed hereinafter with respect to FIG. 12. FIG. 5C also illustrates that the input assembly 512 also includes a gasket 556 sealing the lens 518 to the diffuser 524.

Various examples provide a number of technical improvements and advantages. In some examples, the input assembly 404 may permit low-cost and easy repair and replacement of the serviceable assembly 552 without removing the bottom assembly 560. The arrangement also may reduce or remove the risk of fluid or debris infiltrating the button deck 400 (similar to the button deck 120 of FIG. 1). Examples disclosed also serve to eliminate or reduce damage to substrate 410 through the elimination of holes in the button deck 400. Without holes in the button deck 400, solvents and other fluids may be used to remove adhesive or clean the button deck without the need to open the EGM or remove the entire button deck 400. In some other examples, after the serviceable assembly 552 has been removed, another or a newly designed serviceable assembly may be installed on the aperture-less glass 532. In still other examples, the aperture-less glass 532 may be repurposed in other gaming devices because the aperture-less glass 532 remains hole less after the serviceable assembly 552 has been removed.

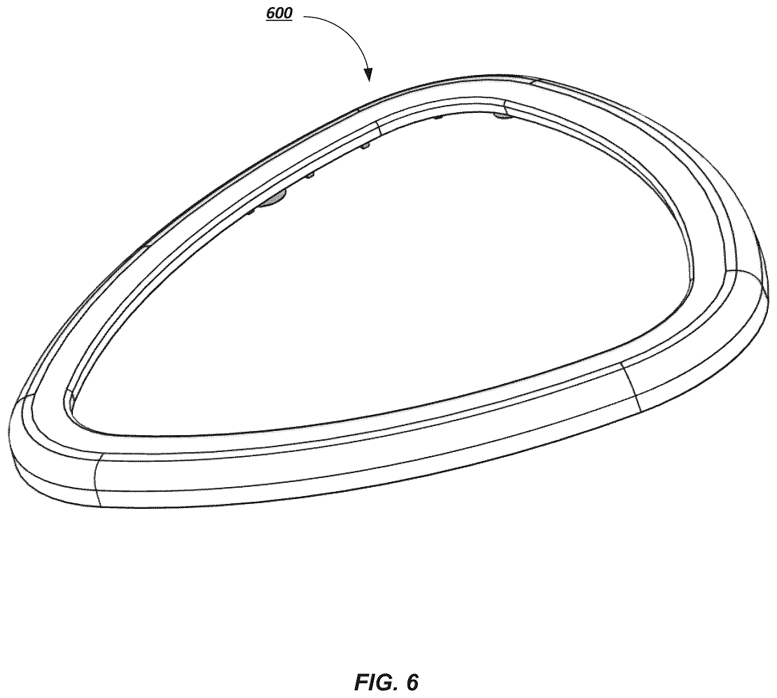

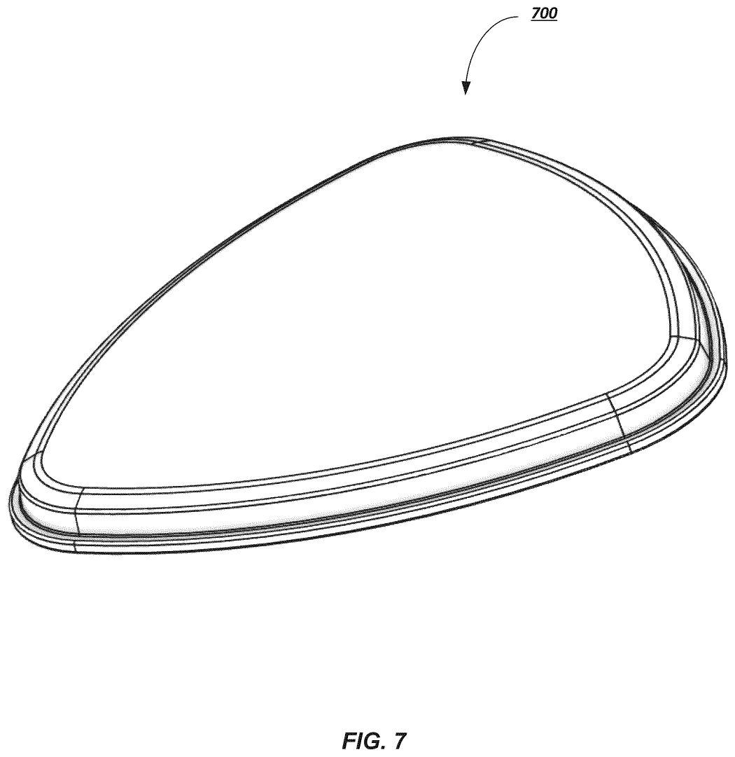

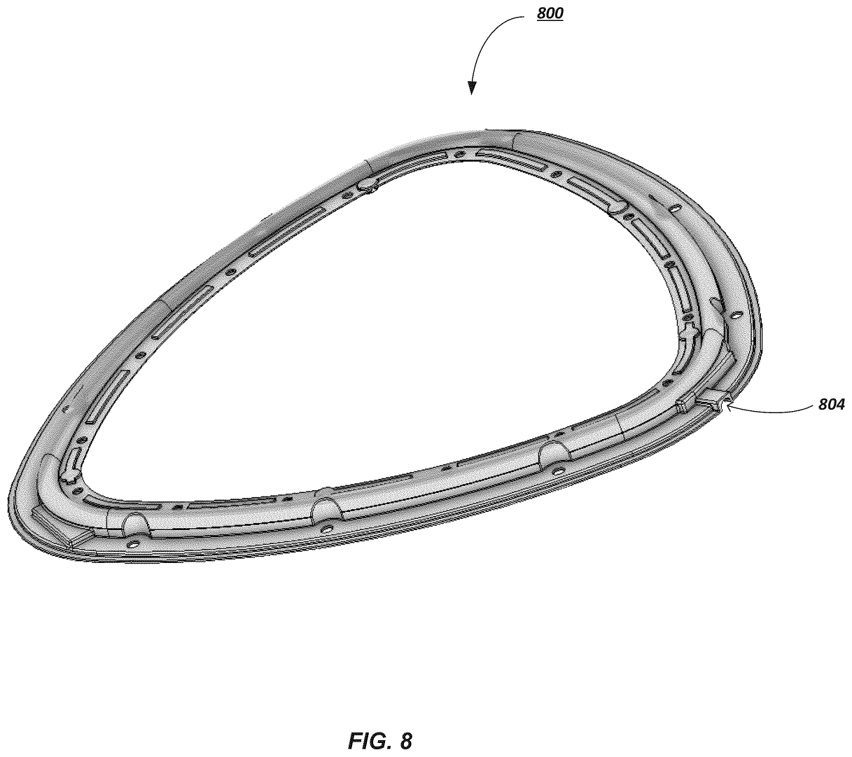

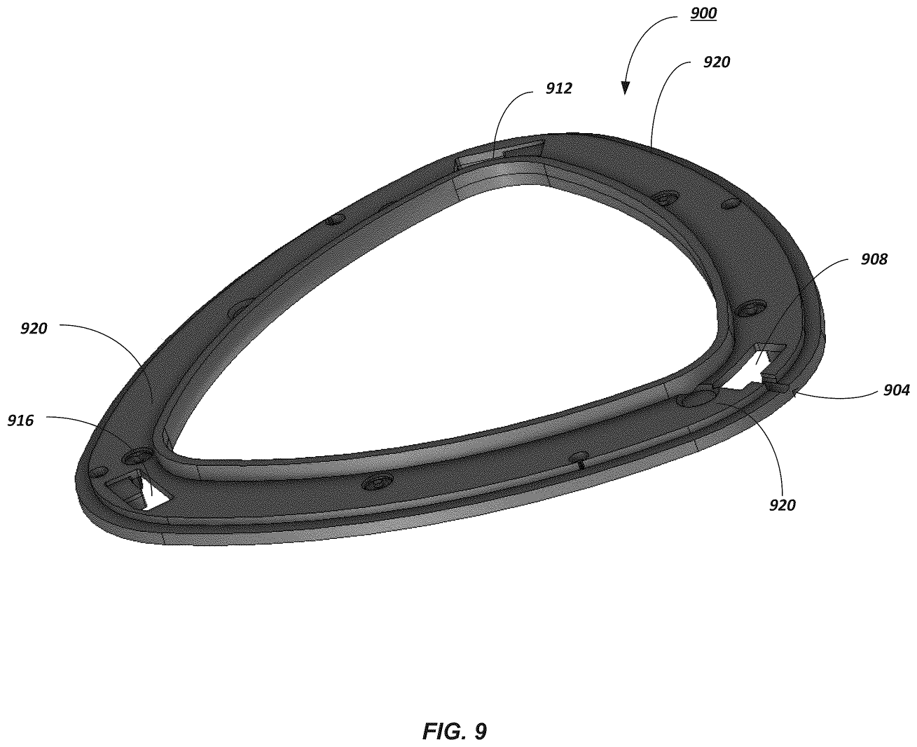

FIG. 6 illustrates a bezel or a frame 600 (similar to the frame 520 of FIG. 5C) for use with the input assembly 512 of FIG. 5A. The frame 600 is generally a ring that receives lens 700 (similar to the lens 518 of FIG. 5C) as shown in FIG. 7, and a gasket 800 (similar to the gasket 556 of FIG. 5C) as shown in FIG. 8, wherein like numerals refer to like parts, and wherein some parts are removed for clarity purposes. The gasket 800 defines a first portion 804 of a channel through which a set screw or a fastener may be inserted to secure the gasket 800 and a diffuser 900 (similar to the diffuser 524 of FIG. 5C) in FIG. 9, wherein like numerals refer to like parts, and wherein some parts are removed for clarity purposes. As shown, the diffuser 900 includes a second portion 904 that completes the channel discussed above. In some examples, the set screw or the fastener may be inserted into the channel formed from the first portion 804 and the second portion 904, and secured to one of flanges 564 of FIG. 5C, wherein the channel has an upper half corresponding to the first portion 804 and a lower half corresponding to the second portion 904 and can connect to hole 908. When the set screw or the fastener have been threaded into or tightened to the rotational lock 548, the frame 600 may then cap or engage both the diffuser 900 and the gasket 800. Also as shown in FIG. 9, the diffuser 900 includes a plurality of through holes 908, 912, 916 operable to receive flanges 564 of FIG. 5C, and secure flanges 564 at peripheral deck 920 when the serviceable assembly 552 is rotatably attached to the rotational lock 548 in section 534, discussed hereinafter. In some other examples, the frame 600 may also include one or more through holes or threaded holes, through which set screws or fasteners may be inserted or threaded into to secure the rotational lock 548 to the frame 600. In some other examples, other locking mechanisms may be used to secure the serviceable assembly 552 to the glass assembly 534, without the channel formed, or with push-and-twist clips.

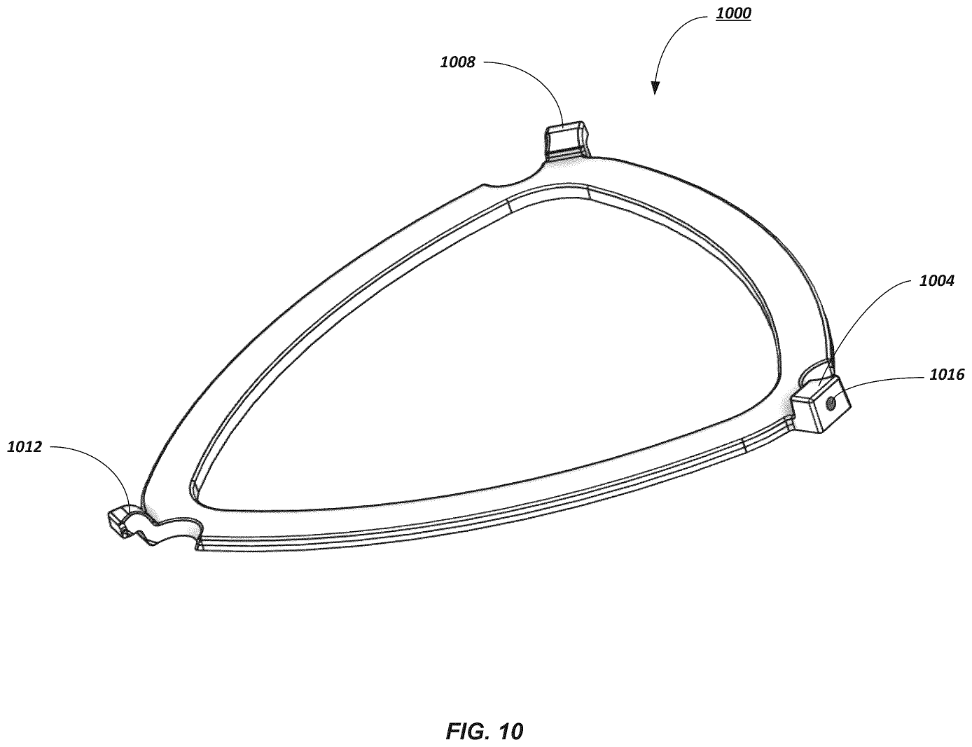

Specifically, FIG. 10 illustrates a rotational lock 1000 (similar to the rotational lock 548 of FIG. 5C) that includes a plurality of flanges 1004, 1008, and 1012 (similar to the flanges 564 of FIG. 5C), wherein like numerals refer to like parts, and wherein some parts are removed for clarity purposes. As discussed above, the rotational lock 1000 may be permanently or removably bonded to the aperture-less glass 532 with a VHB adhesive layer. As shown, unlike flanges 1008 and 1012, flange 1004 also includes a threaded hole 1016 operable to receive the set screw or the fastener so as to secure the serviceable assembly 552 to the aperture-less glass 532 (of FIG. 5A) when first portion 804 and second portion 904 are aligned to form the channel as discussed above. Additionally, the flanges 1004, 1008, and 1012 are operable to be inserted into the plurality of through holes 908, 912, 916. Once inserted, the serviceable assembly 552 may be rotated and catch the peripheral deck 920. After attaching the serviceable assembly 552 to the rotational lock 1000 at the peripheral deck 920, a set screw or a fastener may be inserted into the channel and threaded further into the threaded hole 1016 to secure the serviceable assembly 552 in place. Alternatively, or concurrently, the serviceable assembly 552 may be secured to the rotational lock 1000 with magnets. For example, the diffuser 900 may include magnetic materials or plates at predetermined positions to be magnetically secured to the flanges 564 of FIG. 5C. For another example, the diffuser 900 and the peripheral deck 920 may include matching magnetic plates such that the serviceable assembly 552 may be secured to the rotational lock 1000 at the predetermined positions. In still other examples, the diffuser 900 may include both magnetic materials at predetermined positions and through holes to be magnetically and mechanically secured to the flanges 564 of FIG. 5C.

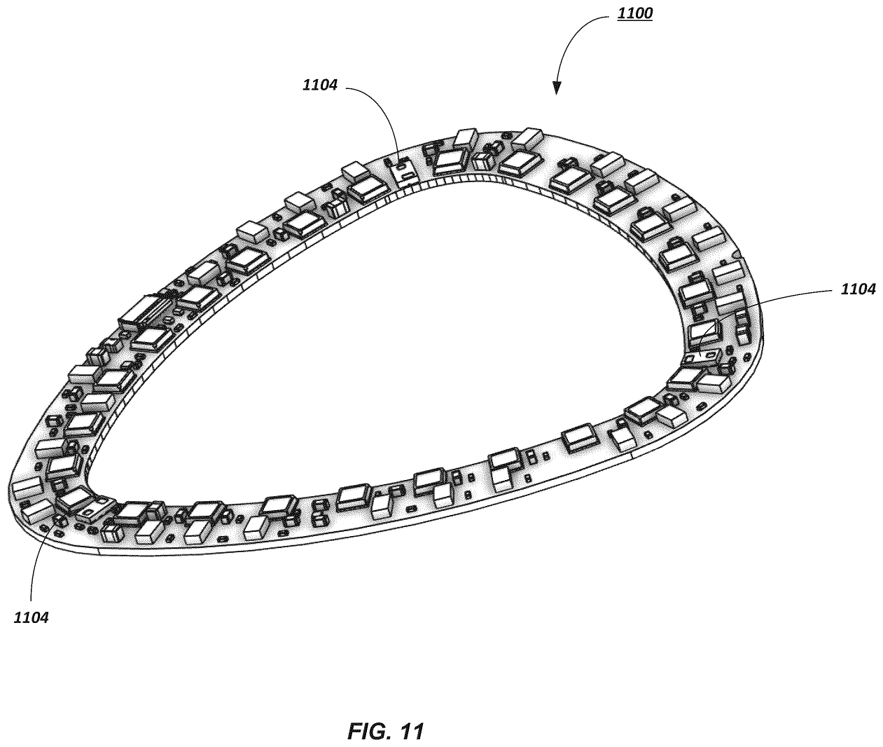

FIG. 11 illustrates a PCBA 1100 to be housed in a PCBA holder 1200 as shown in FIG. 12, which is in turn bonded to the bottom side of the aperture-less glass 532 with a VHB adhesive or other bonding adhesives or agents, wherein like numerals refer to like parts, and wherein some parts are removed for clarity purposes. The PCBA 1100 houses a plurality of sensors and LED's. For example, the sensors may include proximity sensors or infrared (IR) time-of-flight (TOF) sensors, or TOF sensors 1104. Other sensors may include ambient light sensors or other sensors configured for detecting non-transitory signals or tangible properties, such as velocity, momentum, and mass.

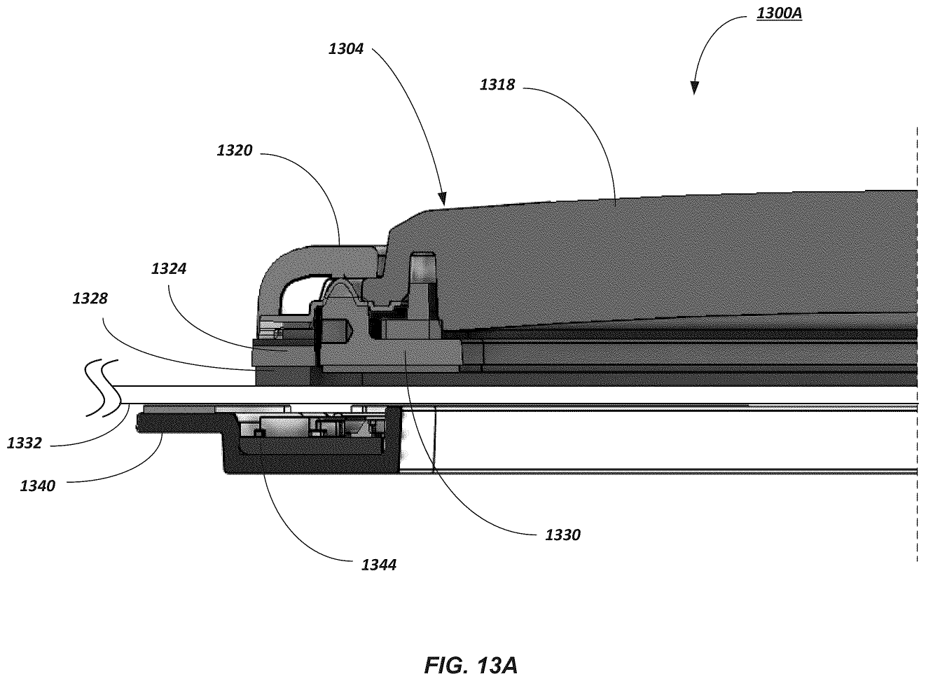

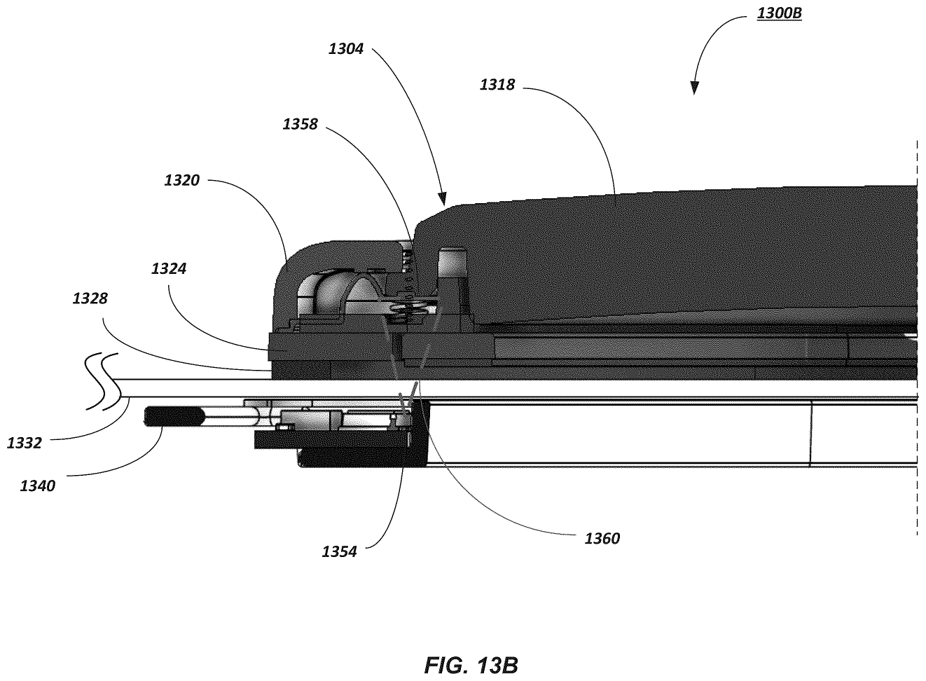

In some examples, the input assembly 1304 as shown in FIG. 13 may also include sensors that are tunable by adjusting one or more beams of laser lights to be emitted, how wide or narrow the beams of laser lights should be, such that, for example, the diffuser 524 may be actuated when movements or displacements are detected by the sensors, the movements or displacements may be communicated to the respective gaming machines or the gaming establishments, or when objects approach respective gaming machines. In some examples, a correlation or relationship between a quantity of TOF sensors 1104 to be deployed and a quantity of edges or corners of the frame 600 (of FIG. 6) or the PCBA 1100 (of FIG. 11) may exist. For example, three TOF sensors are shown on the PCBA 1100 based on the quantity of edges of the frame 600 (of FIG. 6) or the PCBA 1100 (of FIG. 11) generally being three, other numbers of sensors can also be used. The three TOF sensors may utilize, for example, the Hall Effect, to form or yield a cone detection area in the x, y, z-directions. In 2-dimensions, the cone detection area appears as a triangular zone 1360 in FIG. 13B. In other examples, when the lens 700 is a square lens, the input assembly 512 may include four or more TOF sensors to form one or more cone detection areas. In such examples, one or more TOF sensors are utilized for each of the corners of the square lens. As noted above the lens 700 may take a variety of shapes and sizes. In some examples, the quantity of TOF sensors 1104 may be determined by an angle of view of the TOF sensors 1104 deployed, or an amount of displacement of the contact surface 516 relative to the TOF sensors 1104. For example, when the angle of view is 60°, three TOF sensors 1104 fully cover the triangular zone 1360. Other factors may also be used to determine the quantity of TOF sensors to be deployed.

In some examples, the TOF sensors 1104 emit one or more beams of lights to the lens 700 (of FIG. 7). A controller onboard the button deck 400, or the controller 202 of FIG. 2A, may determine how long or amounts of time reflections of the beams of lights are detected after emissions. In some examples, when such reflections are detected, actuations of lens 700 of the input assembly 512, and velocities of the actuations may be measured and communicated to the controller 202, detailed hereinafter.

Further, in some examples, the controller onboard the button deck 400 may store a plurality of baseline times or distances for each of the TOF sensors 1104, the controller onboard the button deck 400 or the controller 202 of FIG. 2A may be configured to continuously measure and communicate current reflection times. Such measured reflection times may be compared to the plurality of baseline times or distances to determine if the reflection times are off the baseline times or thus distances by some predetermined percentages or thresholds, and thus requiring maintenance services. When it is determined that some or all of the reflection times are off the baseline times or thus distances, the controller onboard the button deck 400 or the controller 202 of FIG. 2A may generate signals for maintenance. In some examples, when some or all of the reflection times are off the baseline times or thus distances, the controller onboard the button deck 400 or the controller 202 of FIG. 2A may also shut down the respective gaming devices.

FIG. 13A and FIG. 13B illustrate different cross-sectional views 1300A, 1300B of an input assembly 1304 (similar to 512 of FIG. 5B), wherein like numerals refer to like parts, and wherein some parts are removed or re-described for clarity purposes. The following reside above an aperture-less glass 1332: the input assembly 1304, which includes lens 1318, frame 1320, diffuser 1324, sponge 1328, such that frame 1320 operatively connects to input assembly 1304 to form a secure connection in a fully assembled state, but can also be disassembled when, for example, performing maintenance, and a rotational lock 1330 (similar to the rotational lock 1000 of FIG. 10) adhered to the aperture-less glass 1332. PCBA holder 1340 resides beneath the aperture-less glass 1332. The PCBA holder 1340 holds a PCBA 1344 (similar to the PCBA 1100 of FIG. 11) that holds a TOF sensor 1354. Specifically, as shown in FIG. 13B, the TOF sensor 1354 emits one or more beams of laser lights 1360 towards a tab 1358 of the lens 1318, and the one or more beams of laser lights are reflected and detected by the TOF sensor 1354. A baseline of reflections of the one or more beams of laser lights 1360 may be established when the lens 1318 remains at the home position, or when the lens 1318 is not actuated. Conversely, when lens 1318 is actuated or pressed, reflections of the one or more beams of laser lights 1360 may be changed with respect to the baseline. When the reflections change, the controller onboard the button deck 400 or the controller 202 of FIG. 2A may signal that the input assembly 1304 has been actuated.

The cone detection area formed with the signal, in combination with: (1) mechanical structures such as the tab 1358 and lens 1318, and (2) an algorithm processed by the controller 202, may create a barrier wall. The barrier wall in turn blocks (via the mechanical structures) and/or ignores (via the algorithm) ambient light and noise that may have leaked into assembly 1304. This enhances the accuracy of detected and actuated signals associated with sufficient force supplied against the input assembly 1304. A triggering event can be when, for example, a player presses and supplies enough force against the input assembly 1304 to transmit non-transitory signals, such as the signals that can be detected by TOF sensor 1354.

For the TOF sensor 1354 to achieve an accurate ambient light response, one or more the following characteristics may be tuned or included: (1) diameter of a portion of the substrate 532 through which lights are transmitted from the sensor 1354 to the lens 518 should not be too small; (2) an angle corresponding to a relative radiant intensity and sensitivity±30° to ±40°; and (3) light diameter where 30° lines set at the sides of the opening of the light hole which are rounded.

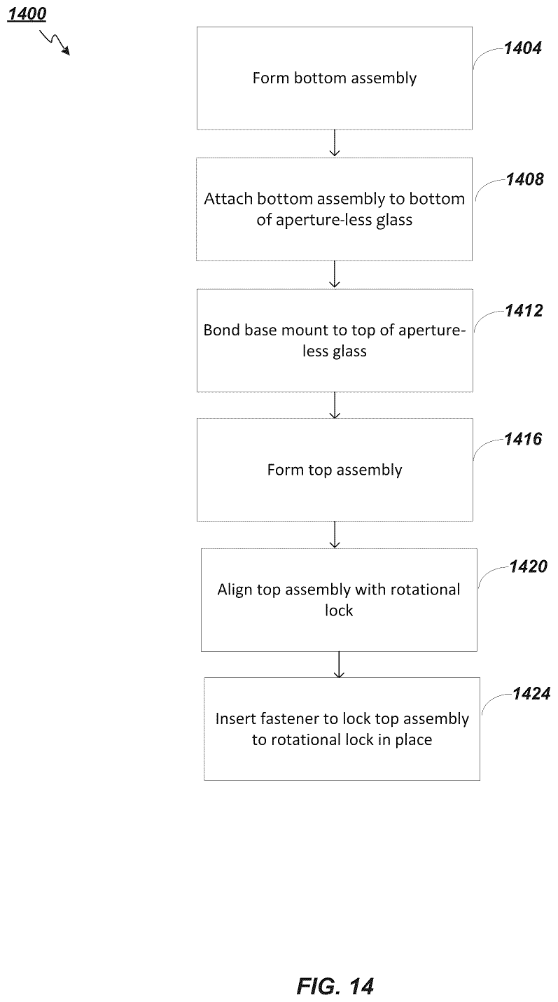

FIG. 14 illustrates an installation process 1400 of a serviceable assembly similar to the serviceable assembly 552 in FIG. 5C. Like numerals refer to like parts, wherein some parts are removed for clarity purposes. Some or all of the steps in the installation process 1400 do not need to be arranged in the order specified or be included in the assembly provided for in this example.

In step 1404, a bottom assembly (similar to the bottom assembly 560 in FIG. 5C) is formed. Specifically, the bottom assembly includes a PCBA holder (similar to the PCBA holder 540 in FIG. 5C) housing a PCBA (similar to the PCBA 544 in FIG. 5C).

In step 1408, the bottom assembly is attached to an aperture-less glass (similar to the aperture-less glass 532 of FIG. 5A) with adhesive agents, such as VHB adhesives (e.g., adhesive layer 536). As discussed above, a portion of the aperture-less glass is transparent for positioning or aligning the bottom assembly (e.g., bottom assembly 560) with the aperture-less glass. In some examples, the bottom assembly (e.g., bottom assembly 560) has a triangular shape. As such, the transparent portion has a corresponding triangular shape. It should be noted that, although the bottom assembly has a triangular shape, other shapes may also be employed to match mechanical components in a top assembly. Further, when other shapes are employed, different clear portion shapes may be employed. For example, when the bottom assembly is circular, the clear portion may have a circular shape for aligning a circular rotational lock.

In step 1412, a base mount (similar to the rotational lock 548 in FIG. 5C) is bonded to the aperture-less glass with adhesive agents, such as VHB adhesives (e.g., adhesive layer 536). As discussed above, a portion of the aperture-less glass is transparent for positioning or aligning the base mount with the aperture-less glass and the bottom assembly. As shown in FIGS. 6-12, the input assembly is generally a triangular input assembly. Thus, the clear portion of the aperture-less glass is generally triangular to receive the triangular input assembly. In other examples, the clear portion includes a number of dotted clear positions for aligning the rotational lock. It should be noted that, although the input assembly is generally triangular, other input assembly shapes may also be employed. For example, when the input assembly is circular, the clear portion may be circular in shape, or may include a number of dotted clear positions on the aperture-less glass forming a circle, for aligning a circular rotational lock.

In step 1416, a top assembly is formed. In some examples, the top assembly includes a lens (similar to lens 518 of FIG. 5C) and a diffuser (similar to diffuser 524 of FIG. 5C) sandwiching a gasket (similar to gasket 556 of FIG. 5C). As discussed above, the gasket and the diffuser may include a channel for receiving a set screw or a fastener. As such, forming the first top sub-assembly at step 1408 includes aligning different portions of the channel, such that the set screw or fastener may be inserted. In some examples, the top assembly may also include a frame, which may have a through hole for receiving the set screw or fastener, operable to capture the lens, the gasket, and the diffuser. In some examples, a sponge (similar to the fluid seal 528 of FIG. 5C) is attached to a bottom side of the diffuser.

In step 1420, the top assembly is aligned with flanges of the rotational lock, and is rotated to land the flanges on a lip (similar to the peripheral deck 920 in FIG. 9) to lock the top assembly in place.

In step 1424, the set screw or fastener is inserted into the channel formed at the diffuser and the gasket, and further threaded into the threaded hole 1016 to secure the serviceable assembly 552 in place.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. A gaming system comprising:
a substrate having a first side and a second side opposite the first side;
a base mount being fixed on an aperture-less portion of the substrate on the first side;
a first assembly having a button and a diffuser, and being removably secured on the base mount, the button being returnably moveable between a first position and a second position different from the first position when the button is actuated resulting in a displacement, and the diffuser separating the button from the base mount; and
a second assembly fixed to the second side of the substrate and having a plurality of sensors operable to transmit lights through the aperture-less portion of the substrate onto the button, and to generate data indicative of the displacement of the button based on the lights transmitted when the button is actuated, and wherein the diffuser is operable to diffuse at least a portion of the lights transmitted into a lit ring above the first side around the first assembly.

2. The gaming system of claim 1, wherein the base mount comprises a plurality of flanges operable to receive the first assembly, and wherein at least one of the flanges defines a through hole to receive one or more fasteners to secure the first assembly to the base mount.

3. The gaming system of claim 1, wherein the diffuser is further operable to absorb another portion of the lights transmitted to prevent unintended lights from escaping into the button.

4. The gaming system of claim 1, wherein the first assembly further comprises a frame sandwiching the button and the base mount.

5. The gaming system of claim 1, wherein the button comprises a lens operable to display at least one of an image and a video.

6. The gaming system of claim 1, wherein the first assembly further comprises a plurality of compression springs operable to return the button from the second position to the first position.

7. The gaming system of claim 1, wherein the plurality of sensors includes infrared time of flight sensors.

8. A gaming input assembly comprising:
an aperture-less substrate having a first side and a second side opposite the first side;
a rotational lock being fixed on the aperture-less substrate on the first side;
a diffuser lockable to the rotational lock;
a button having a tab, and being returnably moveable between a first position and a second position relative to the first side when the button is actuated resulting in a displacement, and wherein the diffuser separating the button from the rotational lock;
a frame sandwiching the button at the tab and the diffuser on the first side, the frame being rotatably secured to the rotational lock; and
a holder housing a plurality of sensors, and being mounted on the second side, the plurality of sensors being operable to transmit lights through the aperture-less substrate onto the tab, and to generate data indicative of the displacement of the tab based on the lights transmitted when the button is actuated, and wherein the diffuser is operable to diffuse at least a portion of the lights transmitted into a lit ring above the first side around the frame.

9. The gaming input assembly of claim 8, wherein the rotational lock comprises a plurality of flanges operable to receive the diffuser, and wherein at least one of the flanges defines a through hole to receive one or more fasteners to secure the diffuser to the flanges.

10. The gaming input assembly of claim 8, wherein the diffuser is operable to diffuse at least a portion of the lights emitted such that the portion of the lights emitted is observable around the button.

11. The gaming input assembly of claim 8, wherein the button comprises a lens operable to display at least one of an image and a video.

12. The gaming input assembly of claim 8, further comprising a plurality of compression springs operable to return the button from the second position to the first position.

13. The gaming system of claim 1, wherein the plurality of sensors includes infrared time of flight (IR-TOF) sensors.

14. A method of implementing a serviceable assembly for use with a gaming device, the gaming device comprises an aperture-less substrate having a top side and a bottom side opposite the top side, a lens, a diffuser having a first channel, a gasket having a second channel, a rotational lock having a flange, a frame having a third channel, and a holder having a plurality of sensors, the method comprising:
bonding the rotational lock to the aperture-less substrate on the top side;
forming the serviceable assembly including aligning the first channel, the second channel, and the third channel to form a fourth channel, and rotatingly locking the serviceable assembly to the rotational lock;
securing the frame to the rotational lock with a fastener through the fourth channel;
bonding the holder on the bottom side of the aperture-less substrate;
transmitting a plurality of lights through the aperture-less substrate onto the lens and the diffuser;
diffusing at least a portion of the lights transmitted into a lit ring above the top side around the serviceable assembly; and
generating data indicative of a displacement of the lens when the lens is actuated based on the lights transmitted when the lens is actuated.

15. The method of claim 14, wherein the aperture-less substrate is ceramic glass, or a clear acrylic base.

16. The method of claim 14, further comprising controlling the diffuser to absorb another portion of the lights transmitted to prevent unintended lights from escaping into the lens.

17. The method of claim 14, further comprising sandwiching the lens and the rotational lock with the diffuser.

18. The method of claim 14, further comprising displaying through the lens at least one of an image and a video.

19. The method of claim 14, further comprising positioning a plurality of compression springs on the diffuser, and biasing the lens to return from a displaced position to a home position with the compression springs.

20. The method of claim 14, wherein the plurality of sensors includes infrared time of flight sensors.
